(19) United States
(12) Patent Application Publication
(10) Pub. No.: US 2017/0111982 A1
(43) Pub. Date: Apr. 20, 2017

(54) ADAPTIVE VACANCY TIMER

(71) Applicant: Robert Bosch GmbH, Stuttgart (DE)

(72) Inventors: Ryan Meitl, Northville, MI (US); Brendan Zimmer, Northville, MI (US)

(21) Appl. No.: 14/886,868

(22) Filed: Oct. 19, 2015

(51) Int. Cl. H05B 37/02

(52) U.S. Cl. CPC H05B 37/0281; H05B 37/0227

(57) ABSTRACT

Systems and methods are described for automatically controlling a lighting device with an adaptive vacancy timer. A first input signal is received indicative of a presence of an occupant and, in response, the at least one lighting device is turned on and a timer is initiated. When a second input signal indicative of the presence of the occupant is received, the timer is incremented by a defined amount. The timer is decremented as time elapses and the at least one lighting device is turned off when the timer is decremented to zero.

### BACKGROUND

The present invention relates to vacancy timer systems for use, for example, in automatic lighting systems. In building systems today, occupancy sensors are often configured with different vacancy timeouts based on time of day, day of week, and location. This automatic lighting control mechanism is intended to provide energy savings based on the normal use-case of the space where the sensor is installed. The timers are typically fixed in duration and are “reset” when occupancy is detected.

### SUMMARY

In various embodiments, the systems and methods described herein remove the need for specific and unique timer configurations based on time of day or day of week. Instead, the systems and methods provide an adaptive vacancy timer that adjusts the vacancy “timeout” based on observed usage of the space and not on a fixed duration timer. This mechanism simplifies the commissioning/installation process and improves the user experience.

In some embodiments, the duration of the vacancy timer is proportional to the amount of activity detected in the space. For example, at regular intervals, the vacancy timer counter will be incremented up or decremented down based on the output of an occupancy sensor. When the occupancy sensor detects presence (i.e., of a person in the space), the timeout counter increments up. When the occupancy sensor detects vacancy, the timer counter is decremented down. In some embodiments, the vacancy timer is also incremented up or down based on other control actions. Each action may have a different associated increment amount.

In one embodiment, the invention provides a method of controlling at least one lighting device. A first input signal is received indicative of a presence of an occupant and, in response, the at least one lighting device is turned on and a timer is initiated. When a second input signal indicative of the presence of the occupant is received, the timer is incremented by a defined amount. The timer is decremented as time elapses and the at least one lighting device is turned off when the timer is decremented to zero.

In another embodiment, the invention provides a lighting system that includes at least one lighting device and at least one input device. An automatic lighting controller is configured to receive a first signal indicative of the presence of an occupant and, in response, turn on the lights and initiate a timer. In response to receiving second input signal indicative of the presence of the occupant, the timer is incremented by a defined amount. The timer is decremented as time elapses and the automatic lighting controller turns off the at least one lighting device when the timer is decremented to zero.

Other aspects of the invention will become apparent by consideration of the detailed description and accompanying drawings.

### BRIEF DESCRIPTION OF THE DRAWINGS

FIG. 1 is a block diagram of a lighting system including the adaptive vacancy timer according to one embodiment.

FIG. 2 is a flow-chart of a method for initiating a timer and turning the lights on using the system of FIG. 1.

FIG. 3 is a flow-chart of a method for adjusting the timer duration based on observed activity and automatically turning the lights off using the system of FIG. 1.

FIG. 4 is a series of timing diagrams showing occupancy detection state, vacancy timer duration, and lighting device state for the system of FIG. 1 implementing the method of FIGS. 2 and 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory, computer-readable medium) executable by one or more processors. As such, it should be noted that a plurality of hardware and software based devices, as well as a plurality of different structural components may be utilized to implement the invention. For example, “control units” and “controllers” described in the specification can include one or more processors, one or more memory modules including non-transitory computer-readable medium, one or more input/output interfaces, and various connections (e.g., a system bus) connecting the components.

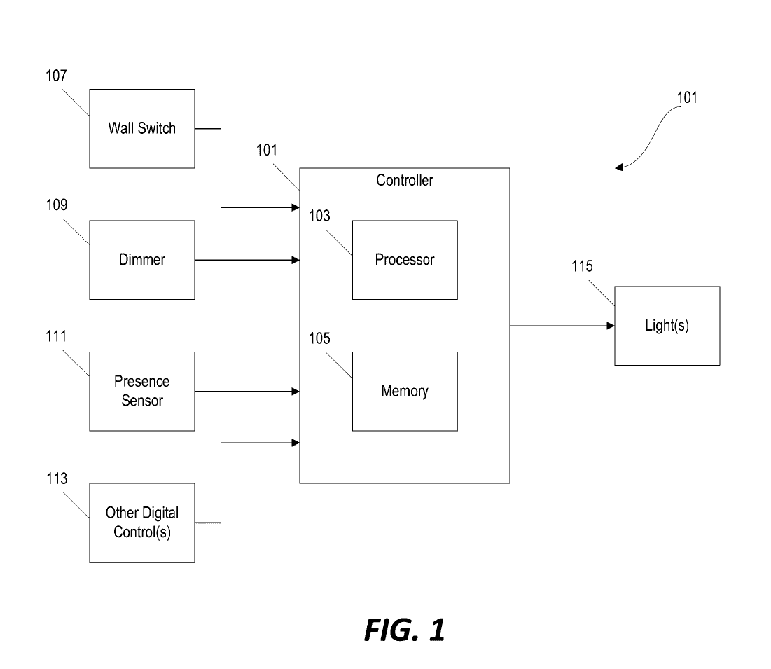

FIG. 1 illustrates a block diagram of a lighting system 100. The lighting system 100 includes a controller 101 that is configured to control the operation of the lighting system based on various input signals. In particular, the control 101 implements the adaptive vacancy timer described in further detail below. The controller 101 includes a processor 103 and a memory 105. The memory 105 includes one or more non-transitory computer-readable memory units including, for example, a FLASH memory module, a hard disk, RAM, or ROM. The memory 105 is communicatively coupled to the processor 103 and stores instructions (e.g., computer code) which are accessed and executed by the processor 103 to control the functionality of the controller 101. In some implementations, the processor 103 and memory 105 are provided as separate physical components (perhaps mounted on the same printed circuit board). However, in other implementations, the processor 103 and memory 105 are provided as a single microcontroller chip.

The controller 101 receives input signals from one or more controls including a wall switch 107, a dimmer 109, a presence sensor 111, or other types of digital controls 113. Based on the input signals from the controls, the controller 101 controls the state of one or more lights 115 that are communicatively coupled to the controller 101 (either by a wired interface or wirelessly). For example, when the state of a wall switch 107 is changed, the controller 101 may change the state of the light (i.e., from “off” to “on”). Furthermore, the controller 101 may increase or decrease the brightness of the lighting device based on an input received through the dimmer control 109. The controller 101 is also configured to automatically turn on the light 115 when the presence sensor 111 indicates that an occupant is detected in the room. The controller 101 maintains a timer and automatically turns off the light(s) 115 when occupancy is not detected for a period of time.

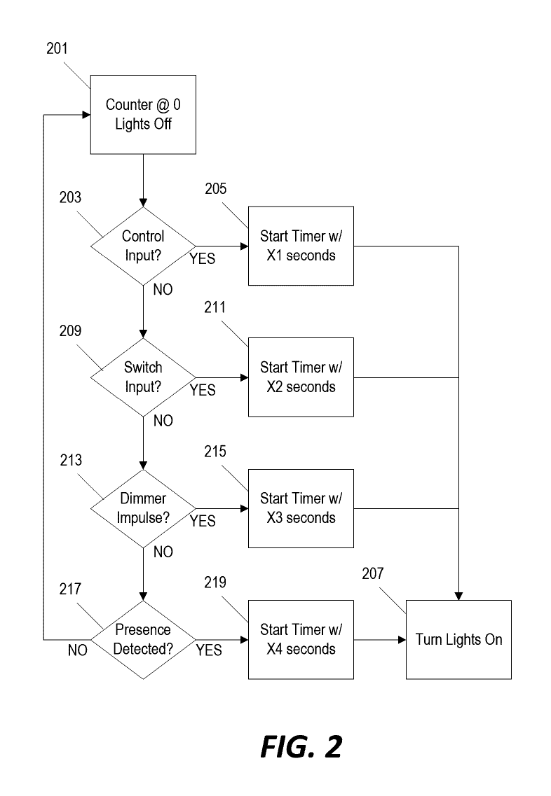

FIG. 2 illustrates a method implemented by the controller 101 (i.e., the processor 103 executing instructions stored on the memory 105) for turning on the lights 115 and for initiating the vacancy timer. When the lights are in an “off” state, the value of the vacancy timer counter is at zero. The controller 101 is configured to periodically check for a control input (step 203), check for a switch input (step 209), check for a dimmer impulse (step 213), and check for an occupant detected by the presence sensor (step 217). If a control input is detected (step 203), the vacancy timer is started with a defined duration (X1)(step 205) and the lights are turned on (step 207). If a switch input is detected (step 209), the controller 101 starts the vacancy timer with defined duration (X2) (step 211). If a dimmer impulse is detected (step 213), the controller 101 starts the vacancy timer with a defined duration (X3) (step 215). Finally, if an occupant is detected in the room by the presence sensor (step 217), the controller 101 starts the vacancy timer with another defined duration (X4) (step 219).

In some implementations, the defined initial duration of the vacancy timer at initiation is the same regardless of the control input that caused the timer to be initiated (i.e., X1=X2=X3=X4). However, in other implementations, the initial duration of the vacancy timer varies depending on the type of control input that is detected by the controller 101. For example, the initial value of the timer may be set higher when a positive action by the user causes the light to be turned on (i.e., when the wall switch is used) and may be set relatively low when the light is turned on automatically because the presence sensor has detected on occupant. As such, in some implementations X1 will be greater than X4. However, it is noted that the exact values for the initial duration settings can vary between implementations and, in some cases, can be programmed by the end user based on preference.

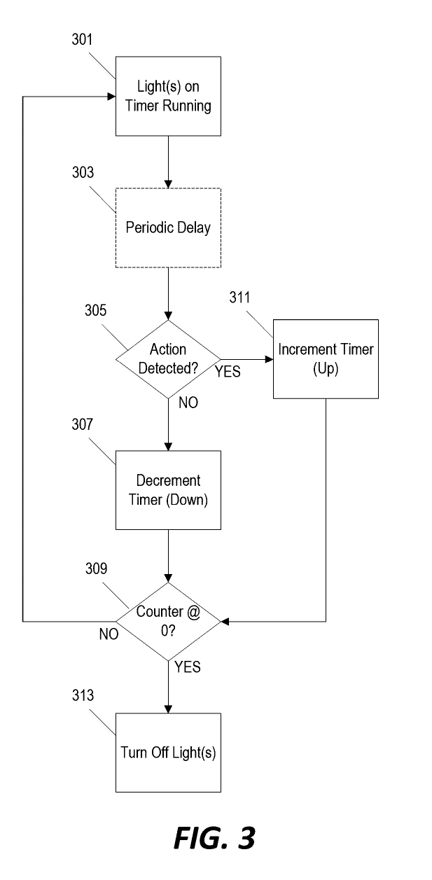

As illustrated in FIG. 3, once the lights are turned on and the timer is running (step 301), the controller 101 periodically queries the sensors (step 303) to determine if any action has been detected (step 305). If an action is detected, the vacancy timer value is incremented (i.e., increased) (step 311). If no action is detected (step 305), the vacancy timer is decremented (i.e., decreased) (step 307). If the vacancy timer has not yet reached zero (step 309), the lights remain turned on (step 301) and the system continues to monitor for activity while increasing or decreasing the vacancy timer. However, once the vacancy timer reaches zero (step 309), the controller 101 automatically turns off the lights (step 313).

By incrementing the counter each time that an action is detected after the delay period, a user can intentionally drive the vacancy timer amount higher by holding the light control button. Similarly, the longer that a user remains in the room and is detected by the presence sensor, the longer that the light will remain turned on after the user leaves the room.

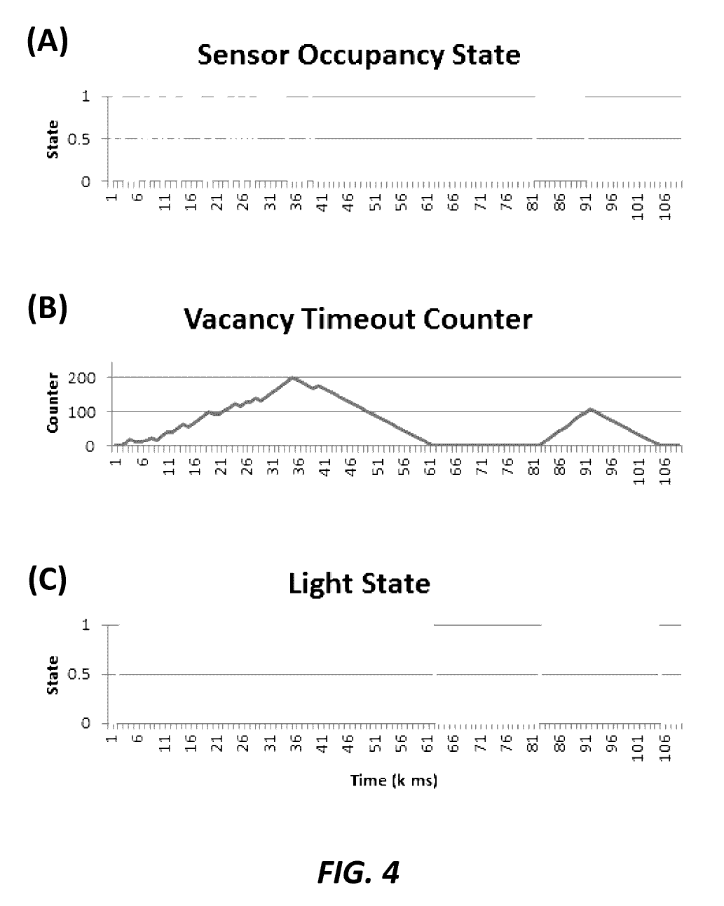

FIG. 4 presents a series of timing diagrams showing the value of the vacancy timer counter (graph (b)) based on detected occupancy (graph (a)) and the resulting on/off state of the light (graph (c)). As shown in graph (a), the presence sensor detects the occupant at 1 second. In response, the vacancy timeout counter, shown in graph (b), is incremented and the lights are turned on (as shown in graph (c)). The vacancy timer continues to increment each time that the presence sensor detects the occupant—all while the lights remain turned on. At around 40 seconds, the system no longer detects the occupant and the vacancy timer is allowed to decrement until it reaches zero at approximately 62 seconds and the lights are turned off. When the occupant is again detected in the room at around 81 seconds, the vacancy timer is again continuously incremented until the occupant is no longer detected at around 92 seconds. The lights again remain turned on until the vacancy timer reaches zero. As demonstrated in the example of FIG. 4, the lights remain on for a longer duration after the occupant leaves the room if the occupant is detected in the room for a longer period of time (i.e., light remains turned on in unoccupied room from ˜41 seconds to ˜61 second and remains on in unoccupied room from ˜91 seconds to ˜106 seconds).

Thus, the invention provides among other things, an adaptive vacancy timer for an automated lighting system that increments a vacancy timer when an action (i.e., the presence of an occupant) is detected, decrements the vacancy timer when no action is detected, and automatically turns off the lights based on the status of the vacancy timer. Various features and advantages of the invention are set forth in the following claims.

1. A method of controlling at least one lighting device, the method comprising:
receiving a first input signal indicative of a presence of an occupant;
turning on the at least one lighting device in response to receiving the first input signal;
initiating a timer in response to receiving the first input signal;
incrementing a duration of the timer by a first defined amount each time a subsequent input signal indicative of the presence of the occupant is received from a first input device wherein the first defined amount is a fixed amount regardless of a current duration of the timer;
decrementing the timer as time elapses; and
turning off the at least one lighting device in response to the duration of the timer decrementing to zero.

2. The method of claim 1, wherein receiving the first input signal includes receiving a signal from a wall-mounted user control indicating that the lighting device has been activated by the occupant.

3. The method of claim 2, further comprising receiving the subsequent input signal from the first input device, the first input device including a presence sensor.

4. The method of claim 1, wherein receiving the first input signal includes receiving a signal from a presence sensor indicative of the occupant present in a room.

5. (canceled)

6. (canceled)

7. The method of claim 1, further comprising:
incrementing the timer by a second defined amount each time an additional signal indicative of the presence of the occupant is received from a second input device, the second defined amount being a fixed amount different from the first defined amount.

8. (canceled)

9. A lighting system comprising:
at least one lighting device;
a first input device configured to generate a first signal in response to detecting a presence of an occupant; and
an automatic lighting controller configured to
turn on the at least one lighting device and initiate a timer;
receive the first signal from the first input device indicative of the presence of the occupant;
increment the timer by a first defined amount in response to receiving the first signal each time the first signal is received from the first input device, wherein the first defined amount is a fixed amount regardless of a current duration of the timer;
decrement the timer as time elapses; and
turn off the at least one lighting device in response to the timer decrementing to zero.

10. The lighting system of claim 9, wherein the first input device includes motion sensor.

11. (canceled)

12. The lighting system of claim 9, further comprising a second input device configured to generate a second signal in response to detecting the presence of the occupant, and wherein the automatic lighting controller is configured to
and
increment the timer by a second defined amount in response to receiving the second signal from the second input device, the second defined amount is a fixed amount different from the first defined amount.

13. The lighting system of claim 9, further comprising a wall-mounted switch, and wherein the automatic lighting controller is further configured to
receive a input signal from the wall-mounted switch in response to an activation of the wall-mounted switch by the occupant, and
turn on the at least one lighting device and initiate the timer in response to receiving the input signal from the wall-mounted switch.

14. The lighting system of claim 9, further comprising a second input device configured to generate a second signal in response to detecting the presence of the occupant, and wherein the automatic lighting controller is further configured to:
turn on the at least one lighting device and initiate the timer with a first initial duration in response to receiving the first input signal from the first input device when the at least one lighting device is turned off, and
turn on the at least one lighting device and initiate the timer with a second initial duration in response to receiving the second input signal from the second input device when the at least one lighting device is turned off.
